(19) United States
(12) Patent Application Publication
(10) Pub. No.: US 2013/0287511 A1
(43) Pub. Date: Oct. 31, 2013

(54) CENTERING METHOD AND APPARATUS

(71) Applicant: Akihiro Yoshimoto, Komatsu-shi (JP)

(72) Inventor: Akihiro Yoshimoto, Komatsu-shi (JP)

(73) Assignee: KOMATSU NTC LTD., Nanto-shi, Toyama (JP)

(21) Appl. No.: 13/880,648

(22) PCT Filed: Oct. 5, 2011
(86) PCT No.: PCT/JP2011/072943

§ 371 Date: Apr. 19, 2013

(30) Foreign Application Priority Data
Oct. 22, 2010 (JP) 2010-236990

(51) Int. Cl. B23B 49/04

(52) U.S. Cl. CPC B23B 49/04
USPC 408/109; 29/559

(57) ABSTRACT

A workpiece centering apparatus has a first work clamp, a second work clamp, and centering drills. The first work clamp is moved in an X-axis direction to make an actual workpiece central axis parallel to a preliminarily given target workpiece central axis, and the centering drills are moved in the X-axis direction to make the actual workpiece central axis with respect to the X-axis direction coincident with the target workpiece central axis with respect to the X-axis direction. The second work clamp is moved in the Y-axis direction to make the actual workpiece central axis parallel to the target workpiece central axis, and the centering drills are moved in the Y-axis direction to make the position of the actual workpiece central axis with respect to the Y-axis direction coincident with the target workpiece central axis with respect to the Y-axis direction.

### TECHNICAL FIELD

The present invention relates to a centering method and apparatus used for machining center holes into both end surfaces of a workpiece such as a crankshaft,

### BACKGROUND ART

It is very important for a body of revolution such as a crankshaft used in vehicle engines to accurately balance its weight during revolution in view of engine properties and high performance. Therefore, the machining positions of center holes, based on which the body of revolution is to be machined, are a critical factor.

One known center hole drilling system is disclosed in Patent Literature 1, which is used for forming, in both surfaces of a workpiece, center holes for use in machining. The center hole drilling system disclosed in this document is configured to have (i) a pair of main clamps (work clamps) that have grippers for gripping main journals located at both ends of a crankshaft material (serving as a workpiece) in order to securely clamp the crankshaft material; (ii) a centripetal chuck for chucking both ends of the crankshaft material gripped by the main clamps for the shape measurement of the crankshaft material; and (iii) a cutting tool for cutting a center hole into both ends of the crankshaft material gripped by the main clamps.

### CITATION LIST

### Patent Literature

Patent Literature 1: JP-A-2010-29994

The center hole drilling system of this type sometimes presents such a problem that when machining parts (drills) located on both sides of the system are moved to specified working positions by indexing and, with these machine parts, centering is performed on a workpiece securely clamped by the pair of work clamps, the center holes to be formed at both ends of the workpiece are not located on the same axis line. More specifically, it sometimes happens that a workpiece central axis C obtained by calculation based on the shape measurement of a workpiece W inclines from the center line of the workpiece W as shown in FIG. 7(a), so that the axis line C₁ of a center hole H₁ located at one end of the workpiece W is not coaxial with the axis line C₂ of a center hole H₂ located at the other end as shown in FIG. 7(b). In such a case, the centering device P of a machining tool (e.g., lathe) to be used in the following processes comes into unsymmetrical contact with the center holes H₁, H₂ as shown in FIGS. 7(c), 7(d) (FIG. 7(d) is an enlarged view of Portion A shown in FIG. 7(c)) so that machining is performed on the workpiece W in such an unsymmetrical contact condition. This causes the workpiece W to deviate in shape from circular form and, in consequence, the accuracy of the machining decreases.

### SUMMARY OF INVENTION

### Technical Problem

The present invention is directed to overcoming the foregoing problem and therefore a primary object of the invention is to provide a centering method and apparatus capable of positioning machining parts, used for forming center holes into both ends of a workpiece, on the same axis line, utilizing a simple configuration.

### Solution to Problem

The above object can be accomplished by a workpiece centering method according to a first aspect of the invention, which method uses a centering apparatus having a first work clamp and a second work clamp for gripping and clamping a workpiece; machining parts for machining center holes into both ends, respectively, of the workpiece being gripped by the first and second work clamps; and machining part moving means for moving the machining parts in an X-axis direction and a Y-axis direction, the X-axis direction and the Y-axis direction being a front-back direction and a vertical direction, respectively, with respect to the body of the apparatus, the method comprising:

a first step for moving the first work clamp in the X-axis direction to make the actual central axis of the workpiece parallel to a preliminarily given target central axis for the workpiece;

a second step for moving the machining parts in the X-axis direction to make the position of the actual central axis of the workpiece with respect to the X-axis direction coincident with the position of the target central axis for the workpiece with respect to the X-axis direction;

a third step for moving the second work clamp in the Y-axis direction to make the actual central axis of the workpiece parallel to the target central axis for the workpiece; and

a fourth step for moving the machining parts in the Y-axis direction to make the position of the actual central axis of the workpiece with respect to the Y-axis direction coincident with the position of the target central axis for the workpiece with respect to the Y-axis direction.

According to a second aspect of the invention, there is provided a workpiece centering method that uses a centering apparatus having a first work clamp and a second work clamp for gripping and clamping a workpiece; machining parts for machining center holes into both ends, respectively, of the workpiece being gripped by the first and second work clamps; and machining part moving means for moving the machining parts in an X-axis direction and a Y-axis direction, the X-axis direction and the Y-axis direction being a front-back direction and a vertical direction, respectively, with respect to the body of the apparatus, the method comprising:

a first step for moving the second work clamp in the Y-axis direction to make the actual central axis of the workpiece parallel to a preliminarily given target central axis for the workpiece;

a second step for moving the machining parts in the Y-axis direction to make the position of the actual central axis of the workpiece with respect to the X-axis direction coincident with the position of the target central axis for the workpiece with respect to the Y-axis direction;

a third step for moving the first work clamp in the X-axis direction to make the actual central axis of the workpiece parallel to the target central axis for the workpiece; and

a fourth step for moving the machining parts in the X-axis direction to make the position of the actual central axis of the workpiece with respect to the X-axis direction coincident with the target central axis for the workpiece with respect to the X-axis direction.

According to a third aspect of the invention, there is provided a workpiece centering apparatus having a first work clamp and a second work clamp for gripping and clamping a workpiece; machining parts for machining center holes into both ends, respectively, of the workpiece being gripped by the first and second work clamps; and machining part moving means for moving the machining parts in an X-axis direction and a Y-axis direction, the X-axis direction and the Y-axis direction being a front-back direction and a vertical direction, respectively, with respect to the body of the apparatus, the apparatus comprising:

first work clamp moving means for moving the first work clamp in the X-axis direction;

second work clamp moving means for moving the second work clamp in the Y-axis direction;

storing means for storing a preliminarily given target central axis for the workpiece; and

work clamp controlling means and machining part controlling means for controlling the first and second work clamp moving means and the machining part moving means respectively such that the first work clamp is moved in the X-axis direction by the first work clamp moving means to make the actual central axis of the workpiece parallel to the target central axis for the workpiece; the machining parts are moved in the X-axis direction by the machining part moving means to make the position of the actual central axis of the workpiece with respect to the X-axis direction coincident with the position of the target central axis for the workpiece with respect to the X-axis direction; the second work clamp is moved in the Y-axis direction by the second work clamp moving means to make the actual central axis of the workpiece parallel to the target central axis for the workpiece; and the machining parts are moved in the Y-axis direction by the machining part moving means to make the position of the actual central axis of the workpiece with respect to the Y-axis direction coincident with the position of the target central axis for the workpiece with respect to the Y-axis direction.

Preferably, the centering apparatus according to the third aspect of the invention is modified such that the control of the first and second work clamp moving means by the work clamp controlling means and the control of the machining part moving means by the machining part controlling means are effected at the same time (Fourth Aspect of the Invention).

### Advantageous Effects of Invention

According to the first to third aspects of the invention, the first work clamp is moved in the X-axis direction that is a front-back direction and the second work clamp is moved in the Y-axis direction that is a vertical direction, so that the center line of the workpiece on which center holes are to be formed can be made parallel to the central axes of both machining parts. In addition, the machining parts for forming center holes into both ends of the workpiece are moved in parallel with each other with their central axes being coincident with each other, so that center holes to be formed are aligned on the same axis line and the center holes in such a coaxial condition can be machined. The machining parts for forming the center holes are provided with X-axis direction and Y-axis direction moving mechanisms for use in end-surface preparation of the workpiece and therefore these moving mechanisms can be utilized without modification. Further, the first work clamp may be provided with a moving mechanism capable of movement only in the X-axis direction whereas the second work clamp may be provided with a moving mechanism capable of movement only in the Y-axis direction. This contributes to simplification of the apparatus configuration.

According to the fourth aspect of the invention, these controls may be effected at the same time so that the time taken for centering can be reduced.

### BRIEF DESCRIPTION OF DRAWINGS

FIG. 1 shows an overall configuration view of a centering apparatus according to one embodiment of the invention.

FIG. 2 is a sectional view taken along line A-A of FIG. 1, which illustrates a moving mechanism for cutter drive tables.

FIG. 3 is a sectional view taken along line B-B of FIG. 1, which illustrates a moving mechanism for a first work clamp.

FIG. 4 is a sectional view taken along line C-C of FIG. 1, which illustrates a moving mechanism for a second work clamp.

FIG. 5 is an explanatory view of a centering method according to the embodiment.

FIG. 6 is an explanatory view of a centering method according to another embodiment.

FIG. 7 is an explanatory view illustrating a problem presented by a prior art technique.

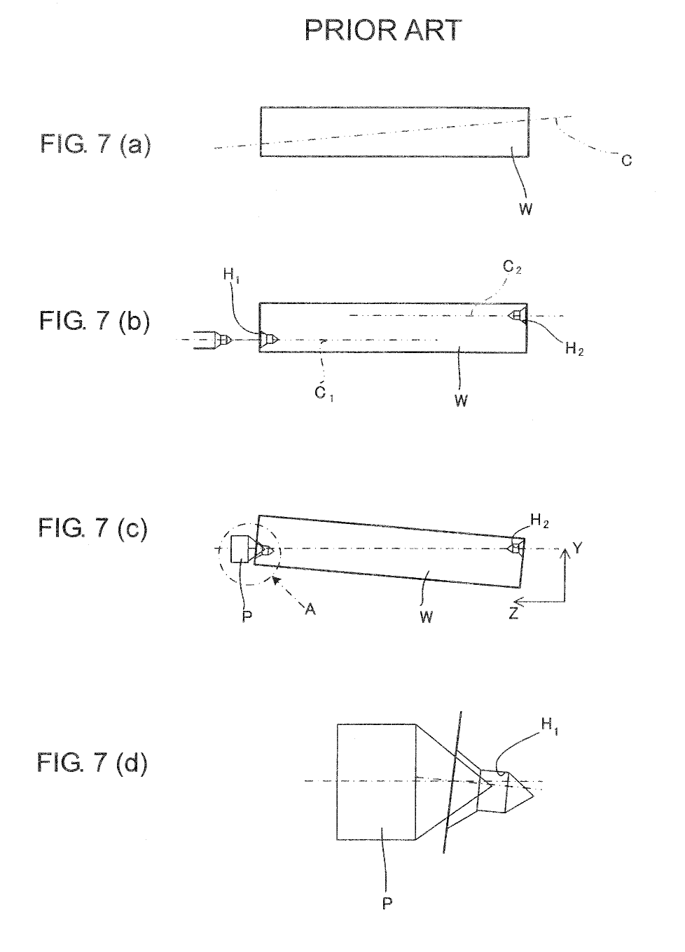

### BEST MODE FOR CARRYING OUT INVENTION

Referring now to the accompanying drawings, a centering method and apparatus will be described in detail according to preferred embodiments of the invention.

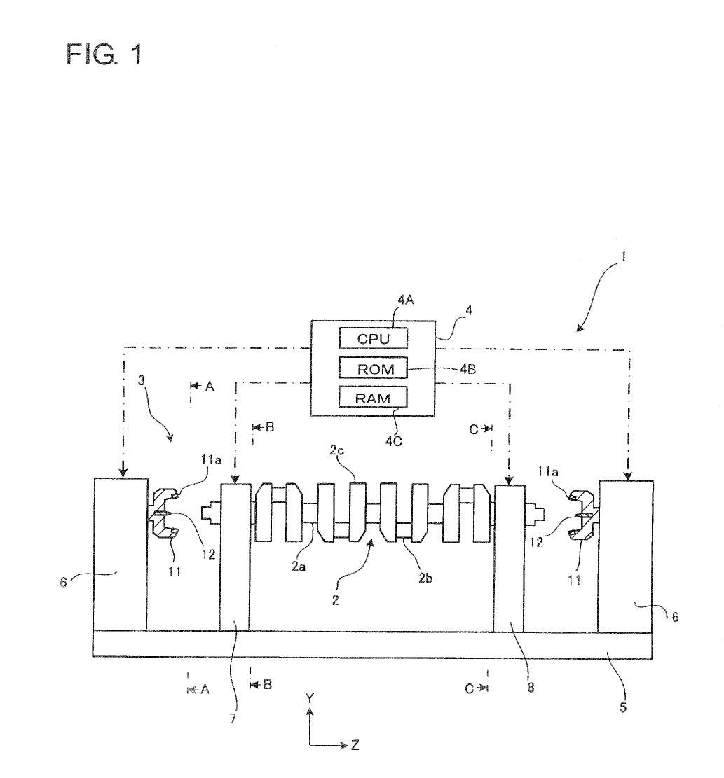

FIG. 1 shows an overall configuration view of a centering apparatus 1 according to an embodiment, which is constituted by a center hole drilling machine 3 and a controller (computer) 4. The center hole drilling machine 3 machines center holes into both end surfaces, respectively, of a crankshaft material (hereinafter referred to as a “crankshaft”) 2 serving as a workpiece, and the controller 4 determines the positions of the center holes to be formed in the workpiece. The crankshaft 2 stated herein is configured to have main journals 2a, pin journals 2b and counter weights 2c.

Although not shown in the drawings, the center hole drilling machine 3 includes a shape measuring instrument for measuring the outer shape of the crankshaft 2 with a laser displacement gauge or the like. The controller 4 is constituted by a central processing unit (CPU) 4A for executing a specified program; a read only memory (ROM) 4B for storing this program and various maps; a random access memory (RAM) 4C that serves as a working memory necessary for executing the program and as various registers; and others. With this arrangement, workpiece shape data (three-dimensional shape data) sent from the shape measuring instrument is input to the random access memory (RAM) 4C of the controller 4.

The center hole drilling machine 3 has a machine body including a machine table (bed) 5 that is installed so as to extend in a Z-axis direction (horizontal direction). A pair of cutter drive tables 6 are installed in the vicinity of both ends of the machine table 5 with respect to the Z-axis direction. A pair of work clamps, i.e., a first work clamp 7 and a second work clamp 8 are installed at different positions of the machine table 5 with respect to the Z-axis direction.

Rotatably mounted on each of the cutter drive tables 6 is a disk-shaped milling cutter 11 that is opposed to an associated end surface of the crankshaft 2. Each milling cutter 11 is provided with a number of milling cutter chips 11a that are circumferentially aligned around the axis of rotation of the milling cutter 11. Provided at the center of the milling cutter 11 is a centering drill (machining part) 12 for forming a center hole into an end surface of the crankshaft 2. It should be noted that when the workpiece is drilled with the centering drills 12, the milling cutter chips 11a for milling are positioned so as to cover their associated end surfaces of the crankshaft 2 from outside so that the milling cutter chips 11a do not interfere with the end surfaces of the crankshaft 2.

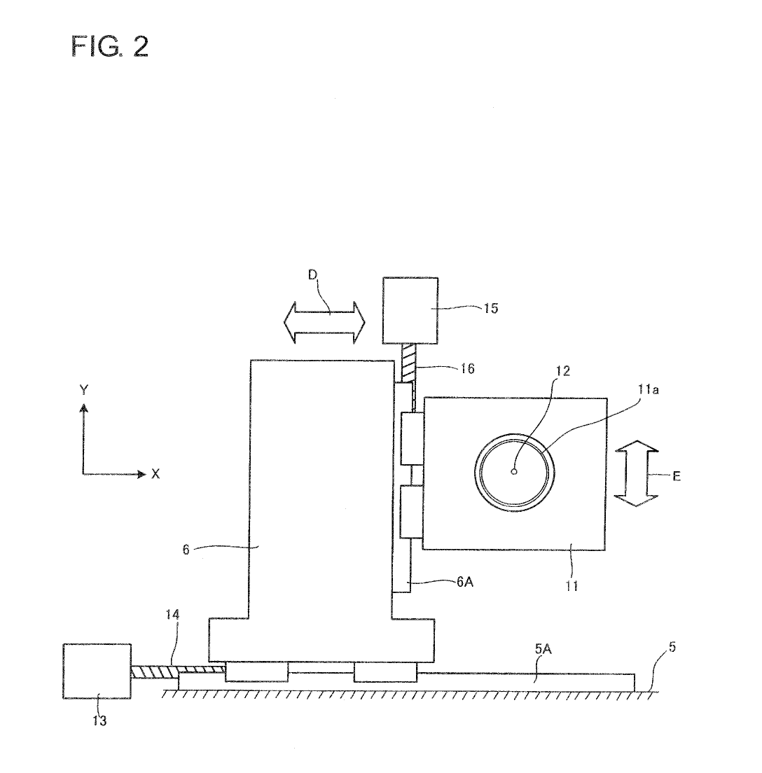

Each of the cutter drive tables 6 houses a motor (not shown) for rotatably driving the milling cutter 11. As shown in FIG. 2, there is provided a mechanism for moving each cutter drive table 6 forward and backward in an X-axis direction (i.e., the direction of arrow D) along a linear guide 5A disposed on the upper surface of the machine table 5 through a ball screw mechanism 14 by actuation of a motor 13, the X-axis direction being a front-back direction of the apparatus. There is also provided a mechanism for lifting and lowering each milling cutter 11 in a Y-axis direction (i.e., the direction of arrow E) along a linear guide 6A attached to a side surface of each cutter drive table 6 through a ball screw mechanism 16 by actuation of a motor 15, the Y-axis direction being a vertical direction of the apparatus. Each cutter drive table 6 is also moved by a moving mechanism (not shown) in a Z-axis direction. These moving operations of the cutter drive tables 6 are controlled in accordance with instruction signals issued by the controller 4. Note that the motors 13, 15 and ball screw mechanisms 14, 16 of this embodiment correspond to the machining part moving means of the invention.

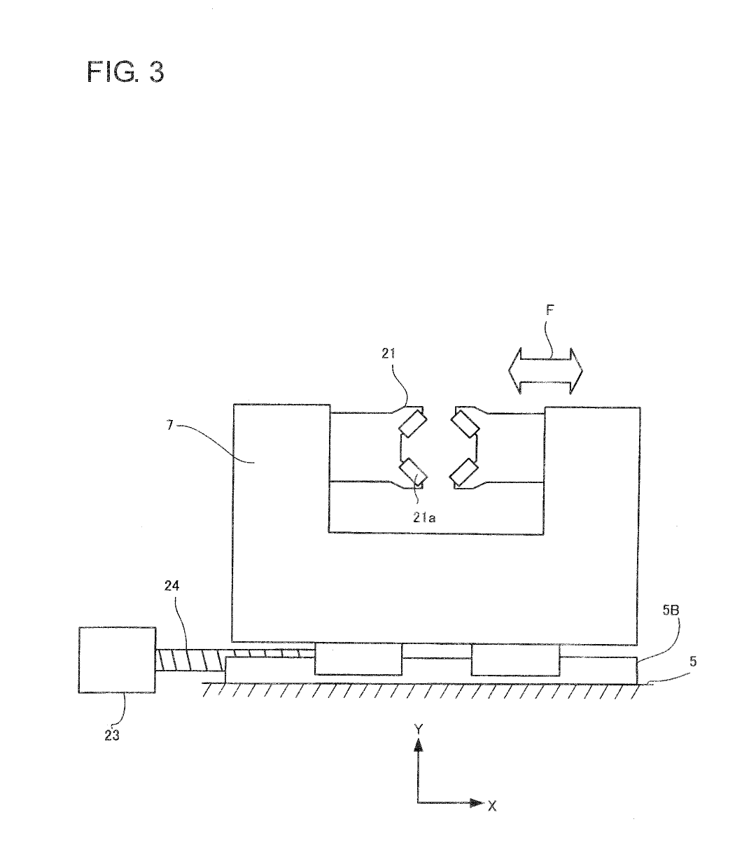

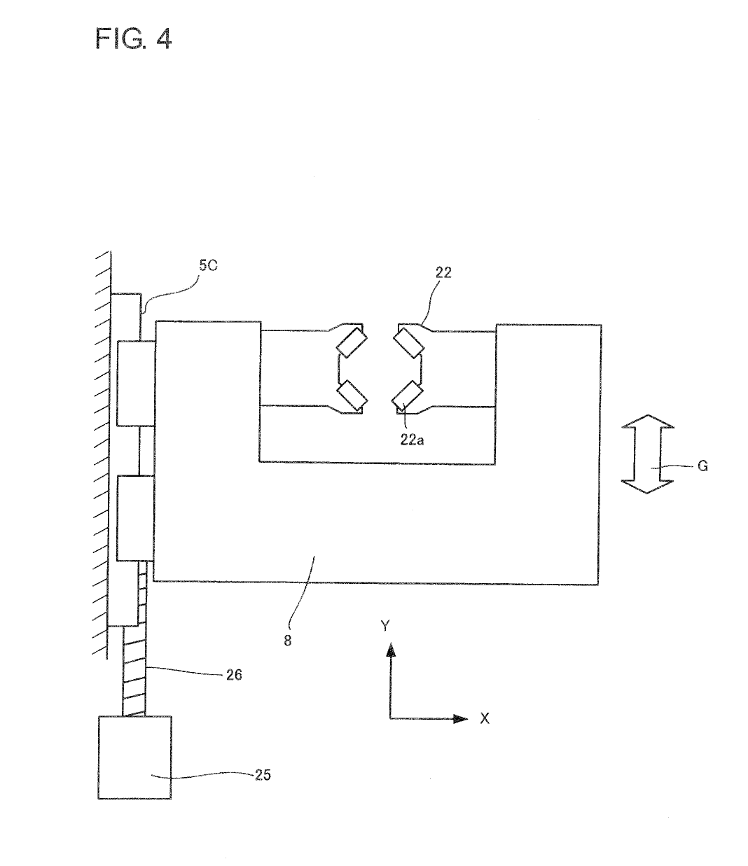

As shown in FIGS. 3 and 4, the first work clamp 7 and the second work clamp 8 have gripping portions 21, 22 respectively. These gripping portions 21, 22 grip the main journals 2a (that are objects to be machined), respectively, of the crankshaft 2 at both sides thereof with respect to a lateral direction (the X-axis direction). Each gripping portion 21 (22) has four chuck pawls 21a (22a) for gripping and clamping its associated main journal 2a.

As illustrated in FIG. 3, the first work clamp 7 is configured to be moved forward and backward in the X direction (the direction of arrow F), which is the front-back direction of the apparatus, along the linear guide 5B disposed on the upper surface of the machine table 5, through a ball screw mechanism 24 by actuation of the motor 23. As illustrated in FIG. 4, the second work clamp 8 is configured to be moved up and down in the Y direction (the direction of arrow G), which is the vertical direction of the apparatus, along the linear guide 5C attached to a side surface of the machine table 5, through a ball screw mechanism 26 by actuation of the motor 25. The moving operations of these work clamps 7, 8 are controlled in accordance with instruction signals issued by the controller 4. Note that the motor 23 and ball screw mechanism 24 of this embodiment correspond to the first work clamp moving means of the invention and the motor 25 and ball screw mechanism 26 correspond to the second work clamp moving means of the invention.

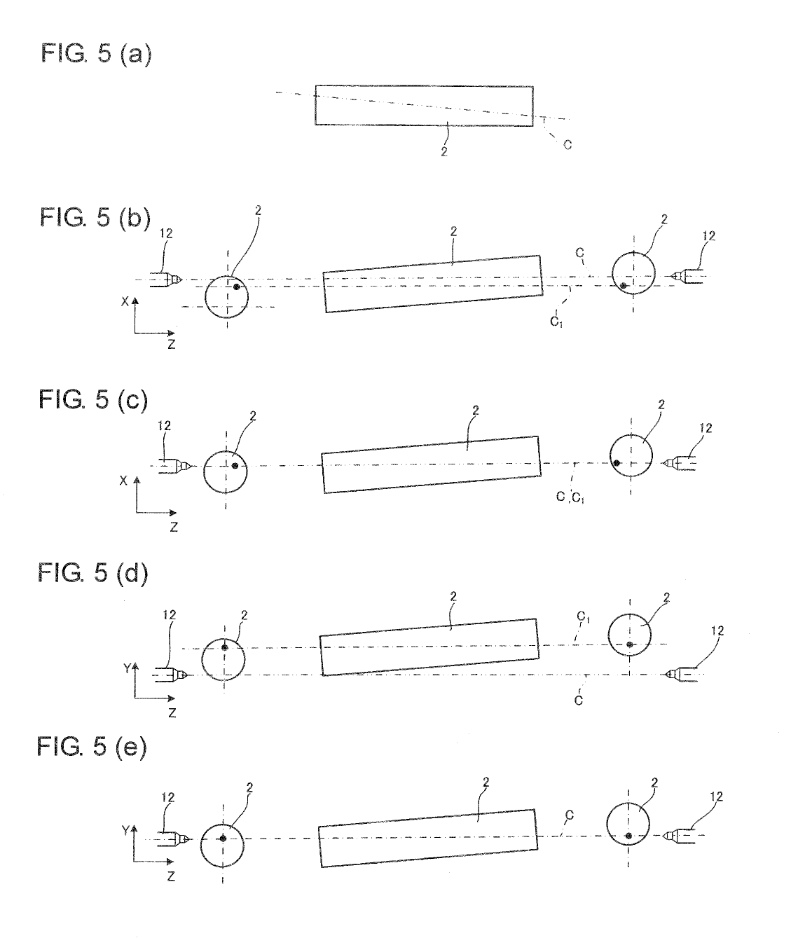

Next, reference is made to FIG. 5 to describe the centering operation performed on the crankshaft (workpiece) 2 by the centering apparatus 1 of this embodiment having the above-described configuration. In FIG. 5, the crankshaft 2 is schematically illustrated in the form of a cylinder for simplicity.

Suppose that a workpiece central axis (i.e., a target central axis for the workpiece) C calculated in the workpiece shape data stored in the random access memory 4C of the controller 4 (i.e., the workpiece shape data obtained by measurement using the shape measuring instrument) inclines from the center line of the workpiece as shown in FIG. 5(a). In this case, centering is performed in accordance with the four steps shown in FIGS. 5(b) to 5(e), using the centering drills 12. It should be noted that FIGS. 5(b), 5(c) show the operation when the X-Z plane is viewed whereas FIGS. 5(d), 5(e) show the same when the Y-Z plane is viewed.

### Step 1

In order to make the position of the present workpiece central axis (the actual central axis of the workpiece) C₁ coincident with the position of the target workpiece central axis C with respect to the front-back direction (X-axis direction), the first work clamp 7 is firstly moved in the X-axis direction while the crankshaft 2 being gripped by the first work clamp 7 and the second work clamp 8, so that the present workpiece central axis (actual workpiece central axis) C₁ is made parallel to the target workpiece central axis C as shown in FIG. 5(b). This makes the actual workpiece central axis C₁ parallel to the centering drills 12 with respect to the front-back direction (X-axis direction).

### Step 2

Subsequently, the centering drills 12 are moved in the X-axis direction to make the position of the actual workpiece central axis C₁ with respect to the X-axis direction coincident with the position of the target workpiece central axis C with respect to the X-axis direction as shown in FIG. 5(c). In this way, the position of the actual workpiece central axis C₁ with respect to the front-back direction (X-axis direction) is made coincident with the positions of the centering drills 12 with respect to the front-back direction (X-axis direction).

### Step 3

Next, in order to make the position of the actual workpiece central axis C₁ coincident with the position of the target workpiece central axis C with respect to the vertical direction (Y-axis direction), the second work clamp 8 is moved in the Y-axis direction thereby making the actual workpiece central axis C₁ parallel to the target workpiece central axis C as shown in FIG. 5(d). In this way, the position of the actual workpiece central axis C₁ with respect to the vertical direction (Y-axis direction) is made parallel to the centering drills 12 with respect to the vertical direction (Y-axis direction).

### Step 4

Subsequently, the centering drills 12 are moved in the Y-axis direction to make the position of the actual workpiece central axis C₁ with respect to the Y-axis direction coincident with the position of the target workpiece central axis C with respect to the Y-axis direction as shown in FIG. 5(e). In this way, the position of the actual workpiece central axis C₁ with respect to the vertical direction (Y-axis direction) is made coincident with the positions of the centering drills 12 with respect to the vertical direction (Y-axis direction).

As has been described above, the position of the actual workpiece central axis C₁ is first made coincident with the position of the target workpiece central axis C with respect to the front-back direction (X-axis direction) and then, they are made coincident with each other with respect to the vertical direction (Y-axis direction), so that the positions of the centering drills 12 can be made coincident with the position of the target workpiece central axis C and therefore the centering drills 12 can pierce center holes so as to be aligned on the same axis line. Accordingly, the center holes can be machined while being kept in such a coaxial condition. The centering drills 12 for machining center holes are usually provided with X-axis direction and Y-axis direction moving mechanisms used for end face preparation of a workpiece, and these moving mechanisms may be utilized in the above steps without modification. The first work clamp 7 may be provided with a mechanism for causing movement only in the X-axis direction and the second work clamp 8 may be provided with a mechanism for causing movement only in the Y-axis direction. That is, there is no need to provide each work clamp with a mechanism capable of movements in both X-axis and Y-axis directions so that the configuration of the apparatus can be simplified.

### Another Embodiment

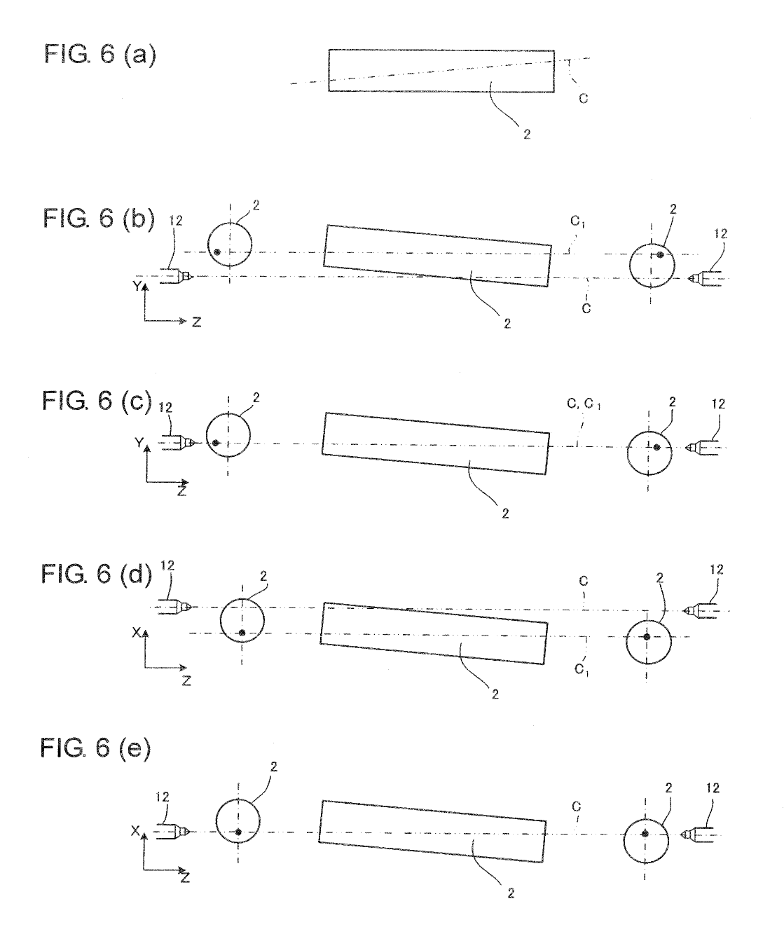

FIG. 6 is an explanatory view showing a centering method according to another embodiment of the invention. While the embodiment shown in FIG. 5 is designed to perform positioning with respect to the vertical direction subsequently to positioning with respect to the front-back direction, this embodiment is designed to firstly perform positioning with respect to the vertical direction and then perform positioning with respect to the front-back direction. The centering method of this embodiment will be hereinafter described according to the order of the steps. It should be noted that FIGS. 6(b), 6(c) show the operation when the Y-Z plane is viewed whereas FIGS. 6(d), 6(e) show the same when the X-Z plane is viewed.

### Step 1

In order to make the position of the present workpiece central axis (the actual central axis of the workpiece) C₁ coincident with the position of the target workpiece central axis C with respect to the vertical direction (Y-axis direction), the second work clamp 8 is firstly moved in the Y-axis direction while the crankshaft 2 being gripped by the first work clamp 7 and the second work clamp 8, so that the present workpiece central axis (actual workpiece central axis) C₁ is made parallel to the target workpiece central axis C as shown in FIG. 6(b). In this way, the actual workpiece central axis C₁ is made parallel to the centering drills 12 with respect to the vertical direction (Y-axis direction).

### Step 2

Subsequently, the centering drills 12 are moved in the Y-axis direction to make the position of the actual workpiece central axis C, with respect to the Y-axis direction coincident with the position of the target workpiece central axis C with respect to the Y-axis direction as shown in FIG. 6(c). In this way, the position of the actual workpiece central axis C₁ with respect to the vertical direction (Y-axis direction) is made coincident with the positions of the centering drills 12 with respect to the vertical direction (Y-axis direction).

### Step 3

Next, in order to make the position of the actual workpiece central axis C₁ coincident with the position of the target workpiece central axis C with respect to the front-back direction (X-axis direction), the second work clamp 8 is moved in the X-axis direction thereby making the actual workpiece central axis C₁ parallel to the target workpiece central axis C as shown in FIG. 6(d). This makes the position of the actual workpiece central axis C₁ with respect to the front-back direction (X-axis direction) parallel to the centering drills 12 with respect to the front-back direction (X-axis direction).

### Step 4

Subsequently, the centering drills 12 are moved in the X-axis direction to make the position of the actual workpiece central axis C₁ with respect to the X-axis direction coincident with the position of the target workpiece central axis C with respect to the X-axis direction as shown in FIG. 6(e). In this way, the position of the actual workpiece central axis C₁ with respect to the front-back direction (X-axis direction) is made coincident with the positions of the centering drills 12 with respect to the front-back direction (X-axis direction).

As has been described above, the position of the actual workpiece central axis C₁ is first made coincident with the position of the target workpiece central axis C with respect to the vertical direction (Y-axis direction) and then, they are made coincident with each other with respect to the front-back direction (X-axis direction), so that the positions of the centering drills 12 can be made coincident with the position of the target workpiece central axis C and therefore the centering drills 12 can pierce two center holes so as to be aligned on the same axis line. Thus, this embodiment has the same effect as of the embodiment described earlier.

Although Steps 1 to 4 are effected in order in the foregoing embodiments, these Steps 1 to 4 can be concurrently effected thanks to the controller 4 that can simultaneously perform the movement control of the cutter drive tables 6 in the X-axis and Y-axis directions, the movement control of the first work clamp 7 in the X-axis direction and the movement control of the second work clamp 8 in the Y-axis direction. This enables it to reduce the time taken for centering. In cases where Steps 1 to 4 are concurrently effected, the position adjustment of the actual workpiece central axis C₁ and the target workpiece central axis C with respect to the front-back direction (X-axis direction) is done at the same time with their position adjustment with respect to the vertical direction (Y-axis direction), and therefore the two embodiments described above are combined into a single embodiment.

Although the foregoing embodiments have been described with cases in which the first work clamp 7 is moved in the X-axis direction whereas the second work clamp 8 is moved in the Y-axis direction, the first work clamp 7 may be moved in the Y-axis direction and the second work clamp 8 may be moved in the X-axis direction. Although a crankshaft is used as an example of the workpiece in the foregoing embodiments, the workpiece is not necessarily limited to crankshafts but the invention is applicable to various members.

Although a workpiece central axis (target workpiece central axis) C is calculated based on the shape data (three-dimensional shape data) of the workpiece obtained by measurement with a shape measuring instrument mounted to the center hole drilling machine 3 in the foregoing embodiments, this target workpiece central axis may be manually inputted to the controller 4 by the operator.

It should be noted that the random access memory 4C of the controller 4 in the foregoing embodiments corresponds to the storing means of the invention and the central processing unit (CPU) 4A of the controller 4 in the foregoing embodiments corresponds to the work clamp controlling means and machining part controlling means of the invention.

### INDUSTRIAL APPLICABILITY

The invention exerts a marvelous effect when applied to a centering apparatus (centering machine) for drilling a center hole at both ends of a workpiece in the initial machining stage of a crankshaft process line.

### REFERENCE NUMERALS

1: centering apparatus

2: crankshaft material (workpiece)

3: center hole drilling machine

4: controller (computer)

6: cutter drive table

7: first work clamp

8: second work clamp

11: milling cutter

12: centering drill

13, 15, 23, 25: motor

14, 16, 24, 26: ball screw mechanism

C: target workpiece central axis

C₁: actual workpiece central axis

1. A workpiece centering method that uses a centering apparatus having a first work clamp and a second work clamp for gripping and clamping a workpiece; machining parts for machining center holes into both ends, respectively, of the workpiece being gripped by said first and second work clamps; and machining part moving mechanism for moving said machining parts in an X-axis direction and a Y-axis direction, said X-axis direction and said Y-axis direction being a front-back direction and a vertical direction, respectively, with respect to a body of the apparatus, the method comprising:
moving said first work clamp in the X-axis direction to make an actual central axis of the workpiece parallel to a preliminarily given target central axis for the workpiece;
moving said machining parts in the X-axis direction to make a position of the actual central axis of the workpiece with respect to the X-axis direction coincident with a position of said target central axis for the workpiece with respect to the X-axis direction;
moving said second work clamp in the Y-axis direction to make the actual central axis of the workpiece parallel to said target central axis for the workpiece; and
moving said machining parts in the Y-axis direction to make the position of the actual central axis of the workpiece with respect to the Y-axis direction coincident with the position of said target central axis for the workpiece with respect to the Y-axis direction.

2. A workpiece centering method that uses a centering apparatus having a first work clamp and a second work clamp for gripping and clamping a workpiece; machining parts for machining center holes into both ends, respectively, of the workpiece being gripped by said first and second work clamps; and a machining part moving mechanism for moving said machining parts in an X-axis direction and a Y-axis direction, said X-axis direction and said Y-axis direction being a front-back direction and a vertical direction, respectively, with respect to a body of the apparatus, the method comprising:
moving said second work clamp in the Y-axis direction to make an actual central axis of the workpiece parallel to a preliminarily given target central axis for the workpiece;
moving said machining parts in the Y-axis direction to make a position of the actual central axis of the workpiece with respect to the Y-axis direction coincident with a position of said target central axis for the workpiece with respect to the Y-axis direction;
moving said first work clamp in the X-axis direction to make the actual central axis of the workpiece parallel to said target central axis for the workpiece; and
moving said machining parts in the X-axis direction to make the position of the actual central axis of the workpiece with respect to the X-axis direction coincident with the position of said target central axis for the workpiece with respect to the X-axis direction.

3. A workpiece centering apparatus comprising:
a first work clamp and a second work clamp for gripping and clamping a workpiece;
machining parts for machining center holes into both ends, respectively, of the workpiece being gripped by said first and second work clamps;
a machining part moving mechanism for moving said machining parts in an X-axis direction and a Y-axis direction, said X-axis direction and said Y-axis direction being a front-back direction and a vertical direction, respectively, with respect to a body of the apparatus;
a first work clamp moving mechanism for moving said first work clamp in the X-axis direction;
a second work clamp moving mechanism for moving said second work clamp in the Y-axis direction;
a storage for storing a preliminarily given target central axis for the workpiece; and
a work clamp controller and a machine part controller for controlling said first and second work clamp moving mechanisms and said machining part moving mechanism respectively such that: (i) said first work clamp is moved in the X-axis direction by said first work clamp moving mechanism to make an actual central axis of the workpiece parallel to said target central axis for the workpiece; (ii) said machining parts are moved in the X-axis direction by said machining part moving mechanism to make a position of the actual central axis of the workpiece with respect to the X-axis direction coincident with a position of said target central axis for the workpiece with respect to the X-axis direction; (iii) said second work clamp is moved in the Y-axis direction by said second work clamp moving mechanism to make the actual central axis of the workpiece parallel to said target central axis for the workpiece; and (iv) said machining parts are moved in the Y-axis direction by said machining part moving mechanism to make the position of the actual central axis of the workpiece with respect to the Y-axis direction coincident with the position of said target central axis for the workpiece with respect to the Y-axis direction.

4. The workpiece centering apparatus as set forth in claim 3, wherein the control of said first and second work clamp moving mechanisms by said work clamp controller and the control of said machine part moving mechanism by said machining part controller are effected at the same time.
